(19) United States
(12) Patent Application Publication
(10) Pub. No.: US 2012/0314035 A1
(43) Pub. Date: Dec. 13, 2012

(54) Human-Perspective Stereoscopic Camera

(76) Inventor: John Peter Hall, Surfside, FL (US)

(21) Appl. No.: 13/517,590

(22) Filed: Jun. 13, 2012

Related U.S. Application Data
(60) Provisional application No. 61/496,131, filed on Jun. 13, 2011.

(51) Int. Cl. H04N 13/02

(52) U.S. Cl. 348/47; 348/E13.074; 348/E13.014

(57) ABSTRACT

A human-perspective stereoscopic camera is an apparatus that is used to capture stereoscopic viewing material that is from the perspective of one person's eyes. The apparatus mainly comprises a left telescopic tube, a right telescopic tube, a fixed pivoting mount, a lateral movement mechanism, and a platform with a channel as a support structure. The left telescopic tube and the right telescopic tube each comprise a first cylinder, a second cylinder, and an optics assembly. The first cylinder and the second cylinder are the means for the telescopic movement. The optics assembly comprises a lens, a digital single-lens reflex camera, a camera mount, a plate, and a pole. The configuration for the components of the optics assembly allows the left telescopic tube and the right telescopic tube to capture stereoscopic viewing material from the perspective of one person's eyes

The current application claims a priority to the U.S. Provisional Patent application Ser. No. 61/496,131 filed on Jun. 13, 2011.

### FIELD OF THE INVENTION

The present invention relates generally to stereoscopic cameras. More specifically, the present invention is a new type of stereoscopic camera that allows the observer to see through the eyes of a specific person and follow the movement of that person's eyes.

### BACKGROUND OF THE INVENTION

The field of stereoscopic viewing, while first introduced by Charles Wheatstone in the early 1800s, has since achieved a resurgence with the new popularity of stereoscopic film. Stereoscopic images attempt to recreate in captured film the human ability to perceive depth, primarily by imitation of the natural human perception of stereopsis. Stereopsis is the effect of the human brain processing two different images from slightly separated eyes. By providing two separate images for viewing, and projecting one image to each eye, stereoscopic viewing achieves binocular disparity due to minor differences between the images, inducing the human brain to process these images as it would typical human vision, and giving the illusion of natural depth even to flat images.

The taking of stereoscopic photographs, or the shooting of stereoscopic film, is achieved by taking two images of the same subject, with the only difference being a slight variation in the position of the camera to the subject, maintaining the same distance to the subject but changing the location from which the second image is taken. While this can be achieved for still objects by moving a single camera to different positions physically and taking multiple photos, to capture moving images, such as is required in creating film, two cameras must simultaneously view the same subject from different positions, thus allowing separate images to be taken at the same time. The current method for achieving this effect involves mounting two cameras a fixed distance apart, typically 60 to 70 millimeters to simulate the distance between the centers of a pair of human eyes. The cameras are then controlled so that it is possible to take simultaneous photographs with both cameras, creating paired images that can be converted to a form that allows stereoscopic viewing.

To achieve the largest functional range, the cameras of the paired stereoscopic photography method are fixed so that the functional axis of each camera is generally parallel to the other. This means that control of image focus is achieved through the manipulation of the focal point of the camera lens, the method used in traditional photography. The human eye, in addition to controlling focus through changing the form of a lens, is also able to create focus on a specific subject through the inward turning of the eyes at slight angles, such that the center of each retina is pointed directly at the subject. This is referred to as vergence movement, and cannot be replicated by cameras fixed to be parallel.

Stereoscopic photography is the conscious effort to simulate as closely as possible the function of the human eye, in order to allow accurate replication of the views achieved by the human eye during image viewing. The present invention attempts to further the imitation achieved by previous stereoscopic camera fixtures towards the end of representing human vision more faithfully in stereoscopic images, when desired. Traditional stereoscopic cameras are unable to achieve the effect of vergence as experienced by the human eye, and as such the focus of images is still determined purely by changes to the focus of the lens capturing the shot. The present invention is a means by which the vergence of the human eye can be replicated in stereoscopic photography for greater imitation of natural human vision, providing a device and method to control the relative angle of a stereoscopic photography unit comprised of two linked cameras.

The intention of recreating the vergence effect is to replicate the ability of the human eye to naturally focus on specific subjects even within a larger scene. While in traditional stereoscopic photography, all objects at the same distance will be seen with the same focus, the effect of vergence between the two cameras of the present device will place the same natural emphasis on a single subject as that found when a human views an object. The device is also designed to be controllable in both rapid and fine adjustments, allowing quick or subtle changes in vergence as is considered necessary by the photographer. The ability to change the vergence of the device while it is in use means that it is well designed for use with film and the capture of moving images. Changes to the angles between stereoscopic cameras previously would have required the disassembly and precise reconstruction of the stereoscopic housing device, if manipulation of the vergence angle was possible at all.

Another component of human vision absent from previous stereoscopic devices is the limited range of focus created with human vision. While a camera, and thus a photographic image, is able to maintain focus over a large field of view, the human eye has limited focus with regards to both distance and area, meaning that there exists a smaller area than the total perceived area on which human vision is fully focused. This is most apparent when observing blurred and indistinct images in human peripheral vision. Alongside the inclusion of a means to recreate vergence, the present invention is able to replicate the smaller focal area of human vision, thus providing further simulation of human vision for stereoscopic viewing, an effect which cannot be created by traditional stereoscopic cameras.

While not all stereoscopic photography intends to recreate the conditions of human viewing with a high degree of accuracy, the ability to do so using the present invention will introduce greater ability for artistic manipulation of stereoscopic images in both photography and film. By introducing the capacity to mimic human vision, a photographer or film-maker can create a viewing experience which more accurately reflects the perceptions of an individual person, which can be utilized for entertainment, education, or any other demand of the film and photography market.

### BRIEF DESCRIPTION OF THE DRAWINGS

FIG. 1 is a perspective view of the present invention.

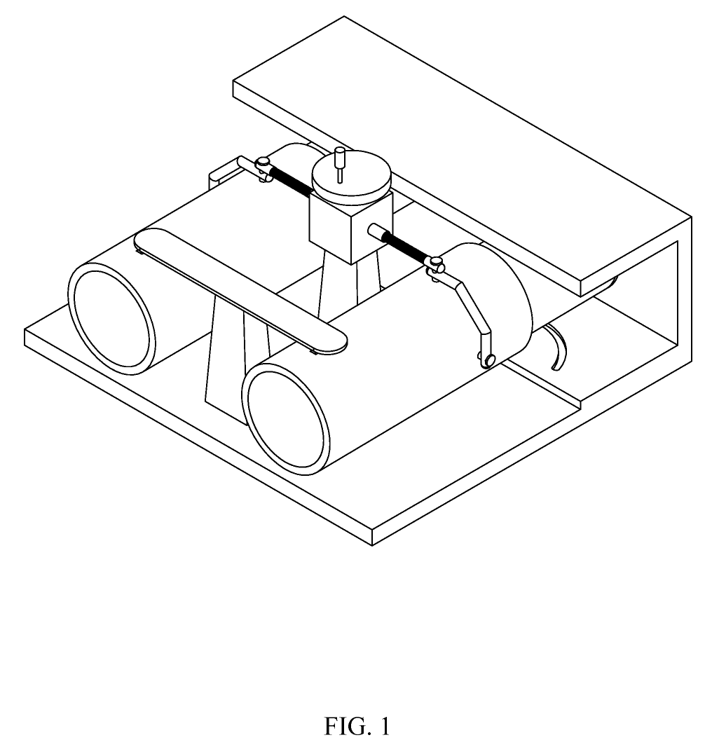

FIG. 2 is a top view of the present invention, where the left telescopic tube and the right telescopic tube are parallel to each other.

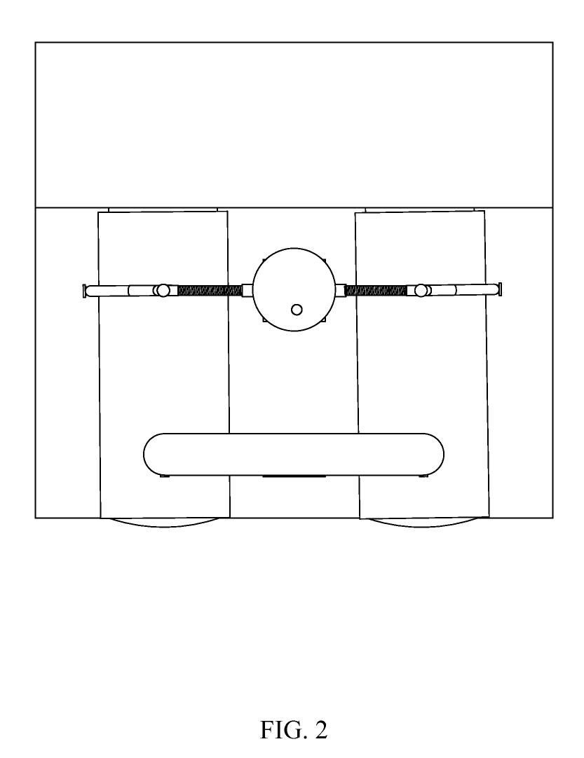

FIG. 3 is a perspective view of the left telescopic tube, the right telescopic tube, the fixed pivoting mount, and the lateral movement mechanism.

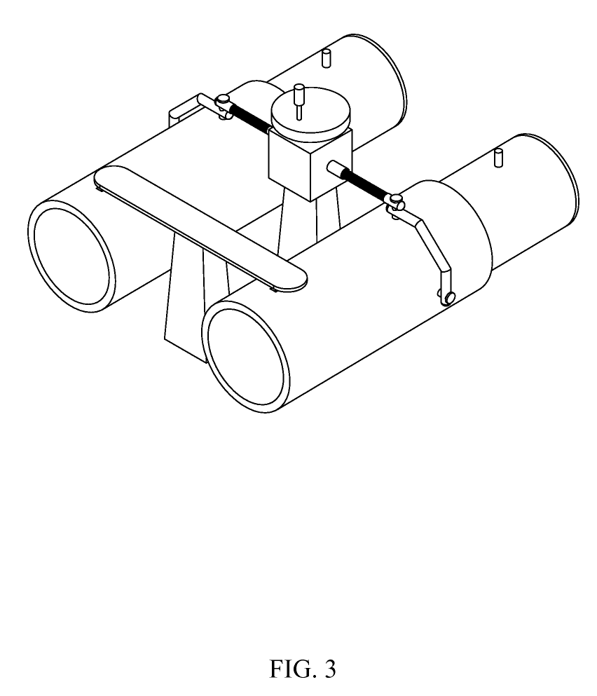

FIG. 4 is a front view of the left telescopic tube, the right telescopic tube, and the lateral movement mechanism.

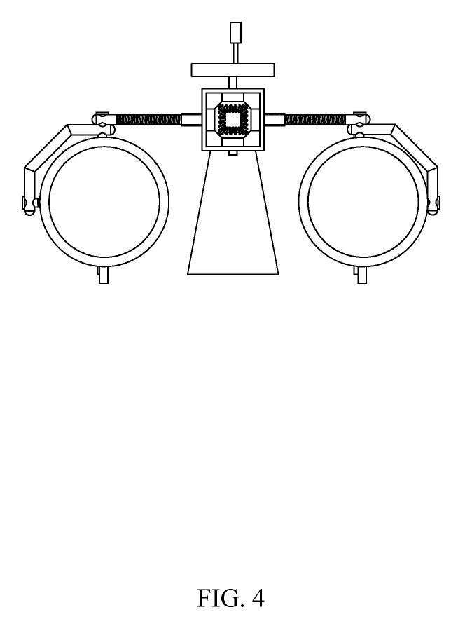

FIG. 5 is a top perspective view of the platform and the channel.

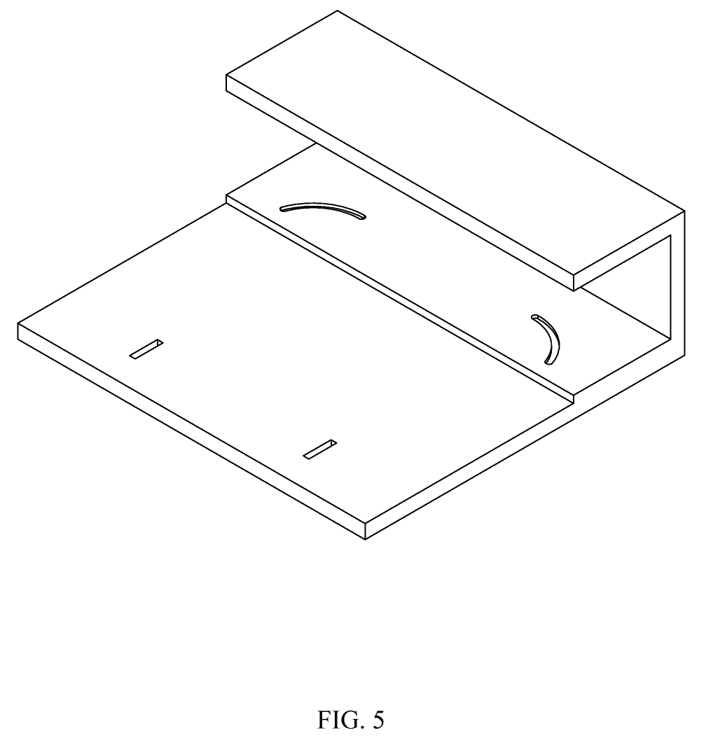

FIG. 6 is a bottom perspective view of the platform and the channel.

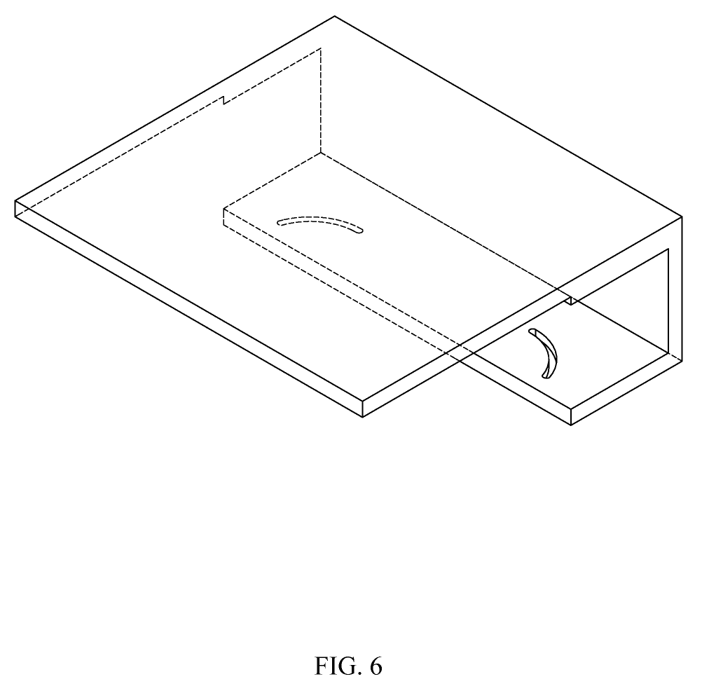

FIG. 7A is a top view of the left telescopic tube, the right telescopic tube, and the lateral movement mechanism, where the left telescopic tube and the right telescopic tube are parallel to each other.

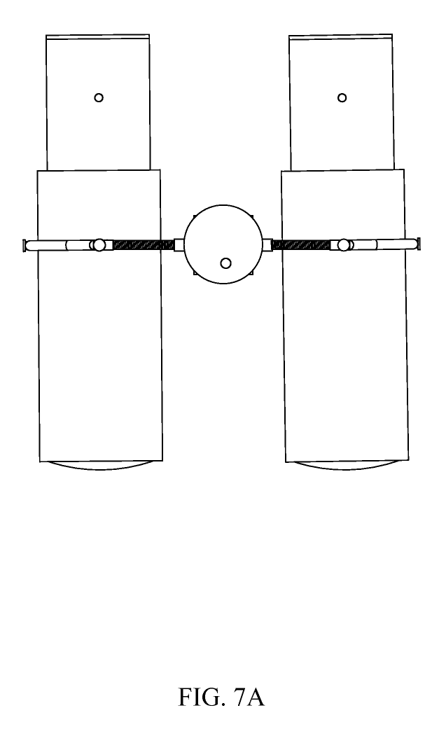

FIG. 7B is a top view of the left telescopic tube, the right telescopic tube, and the lateral movement mechanism, which shows the optical assembly.

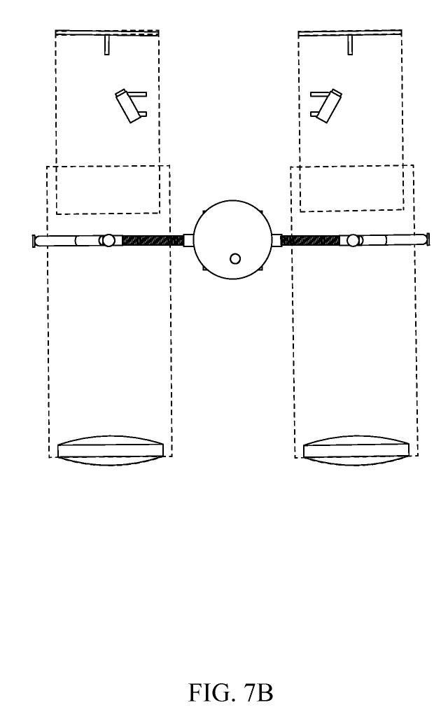

FIG. 8A is a top view of the left telescopic tube, the right telescopic tube, and the lateral movement mechanism, where the left telescopic tube and the right telescopic tube angled towards to each other.

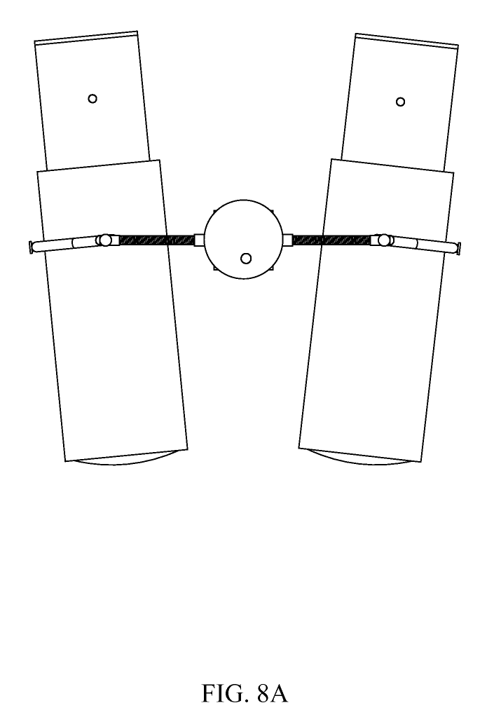

FIG. 8B is a top view of the left telescopic tube, the right telescopic tube, and the lateral movement mechanism, which shows the optical assembly.

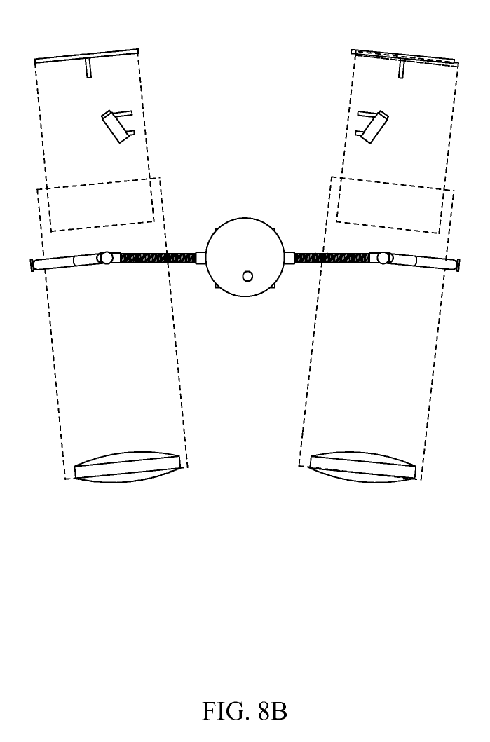

FIG. 9 is a top view of the present invention, where the left telescopic tube and the right telescopic tube are angled towards each other.

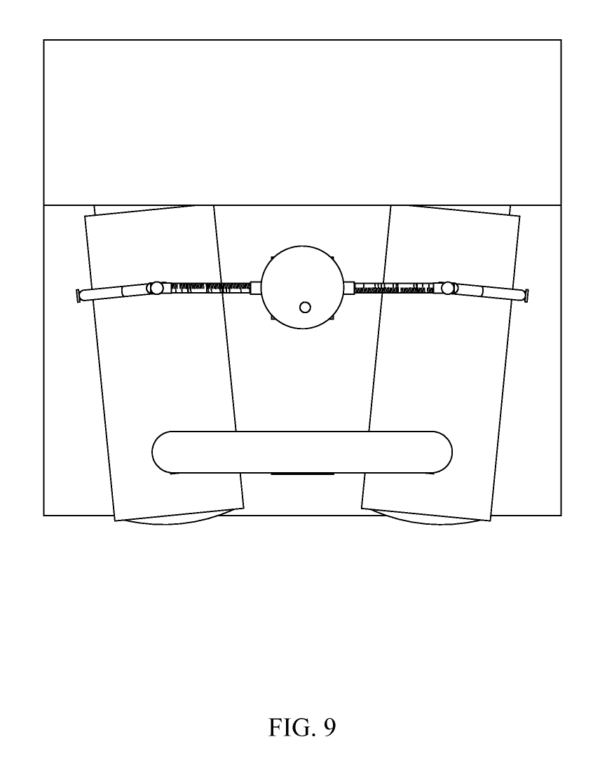

FIG. 10 is an alternate embodiment of the optical assembly.

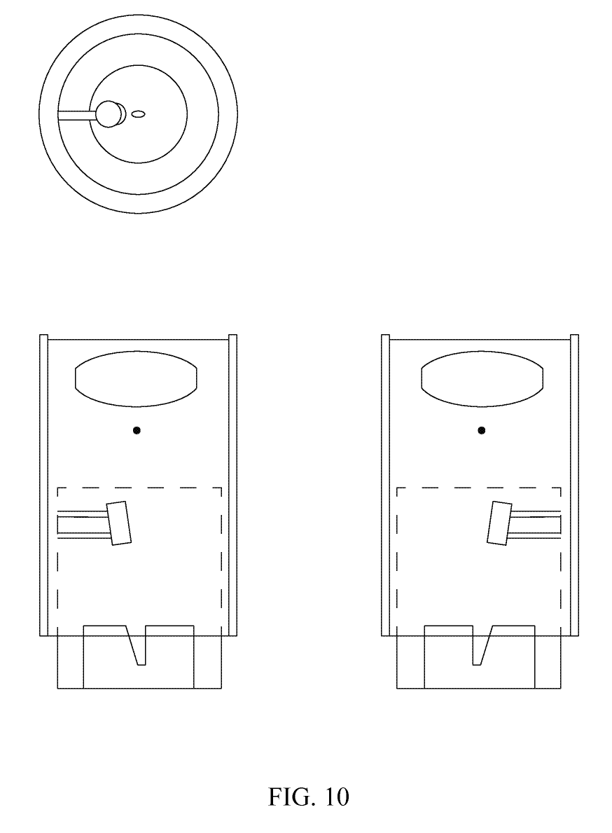

### DETAIL DESCRIPTIONS OF THE INVENTION

All illustrations of the drawings are for the purpose of describing selected versions of the present invention and are not intended to limit the scope of the present invention.

The present invention is a human-perspective stereoscopic camera, which is used to record a stereoscopic movie from the point of view of a left eye and a right eye focusing on far and near objects. The present invention mainly comprises a left telescopic tube, a right telescopic tube, a platform, a channel, a fixed pivoting mount, and a lateral movement mechanism. The left telescopic tube and the right telescopic tube respectively mimics the movements of the left eye and the right eye. In addition, the left telescopic tube and the right telescopic tube respectively records the viewing material from the perspective of the left eye and the viewing material from the perspective of the right eye. The platform and the channel are used to properly position and support the components of the present invention. The fixed pivoting mount allows the front of the left telescopic tube to pivot about a fixed point and allows the front of the right telescopic tube to pivot about another fixed point. The lateral movement mechanism provides the left telescopic tube and the right telescopic tube with equal lateral movement so that the left telescopic tube and the right telescopic tube can rotate about their respective fixed point.

In terms of the general orientation of the components, the platform is positioned below and parallel to the left telescopic tube and the right telescopic tube, which will limit the movement of the left telescopic tube and the right telescopic tube to one plane. The second cylinder of both the left telescopic tube and the right telescopic tube will traverse into the channel, which will again limit the movement of the left telescopic tube and the right telescopic tube to one plane. The channel is connected adjacent to the platform or behind the platform, which creates the base for all of the other components. Also in terms of the general orientation of the components, the fixed pivoting mount is positioned opposite of the channel along the left telescopic tube and the right telescopic tube, which prevents the front of the telescopic tubes from laterally moving and allows the back of the telescopic tubes to laterally move through the channel. The lateral movement mechanism is position in between the fixed pivoting mount and the channel, which provides the back of the telescopic tubes with the means to move laterally through the channel.

The movement and the orientation of the left telescopic tube and the right telescopic tube allow the present invention to capture the stereoscopic viewing material. The left telescopic tube and the right telescopic tube each comprise a first cylinder, a second cylinder, and an optic assembly. The second cylinder traverses into the first cylinder, which allows the second cylinder to be sleeved by the first cylinder. The configuration of the of the second cylinder and the first cylinder allows the left telescopic tube and the right telescopic tube to adjust their length in order to compensate for different viewing objects being at different distances from the present invention. The optic assembly allows the left telescopic tube and the right telescopic tube to record the stereoscopic viewing material. The optics assembly comprises a lens, a digital single-lens reflex (DSLR) camera, a camera mount, a plate, and a pole. The lens is used to converge the incoming light rays from a viewing object. Thus, the lens is encircled by the front of the first cylinder and is positioned opposite to the second cylinder. The light rays that converge through the lens are projected onto the plate, which is where the light rays produce an unfocused image of the viewing object and the surrounding area. Thus, the plate is encircled by the back of the second cylinder and is positioned opposite to the first cylinder. The DSLR camera is used to record the image that is projected into either the left telescopic tube or the right telescopic tube. The DSLR camera should be positioned far enough away from the plate so that the DSLR camera can capture the entire viewing area of the plate. The DSLR camera is connected to the second cylinder by the camera mount, which keeps the DSLR camera at the same distance from the plate while either the left telescopic tube or the right telescopic tube is changing their length. The pole is centrally positioned on the plate and is connected normal to the plate, which allows the light rays converging from the lens to project the center of the image on the other end of the pole. The other end of the pole should be where the light rays from the viewing object converge at a focal point so that only the viewing object in the center of the image is in focus and the surround area is unfocused. If the other end of the pole is not at a focal point, then a user can adjust the orientation of the left telescopic tube and the right telescopic tube with the fixed pivoting mount and the lateral movement mechanism. The other end of the pole for both the left telescopic tube and the right telescopic tube produce two images of the viewing object and the surrounding area, and these two images are used to create the stereoscopic viewing material. The DSLR camera must electronically connected to an image/video editing and viewing system, which allows the user to view the two images produced by the left telescopic tube and the right telescopic and to know if the left telescopic tube and the right telescopic tube need to be reoriented to view the two images in focus. In addition, the DSLR camera is angled toward the pole by the camera mount so that the DSLR is better able to capture the image projected onto the pole and the plate.

The platform and the channel provide the present invention with base that can used to situate and support all the other components. The channel comprises a top flange, a web, and a bottom flange. Typically, the web is positioned in between the top flange and the bottom flange and is perpendicularly connected to the top flange and the bottom flange. Naturally, the top flange is positioned above the left telescopic tube and the right telescopic tube, and the bottom flange is positioned above the left telescopic tube and the right telescopic tube. The top flange and the bottom flange each comprise a left oblique track and a right oblique track. The left oblique track and the right oblique track respectively guide the back of the left telescopic tube and the right telescopic tube laterally away from the center of the present invention. In addition the left oblique track and the right oblique track respectively guide the extension and the contraction of the left telescopic tube and the right telescopic tube. The left oblique track of the top flange and the left oblique track of the bottom flange are aligned to each other, which allow the left oblique track to guide the back of the left telescoping rod from both the top and the bottom. Similarly, the right oblique track of the top flange and the right oblique track of the bottom flange are aligned to each other, which allow the right oblique track to guide the back of the right telescoping rod from both the top and the bottom. The second cylinder comprises a top lateral guide and a bottom lateral guide, which protrusions that are used to engage the left oblique track and the right oblique track. Therefore, the top lateral guide of the left telescopic tube engages the left oblique track of the top flange, and the bottom lateral guide of the left telescopic tube engages left oblique track of the bottom flange. Likewise, the top lateral guide of the right telescopic tube engages the right oblique track of the top flange, and the bottom lateral guide of the right telescopic tube engages right oblique track of the bottom flange.

In addition to the fixed pivoting mount, the platform is used to implement a fixed pivot point for the front of each telescopic tube. The first cylinder comprises a bottom pivot, which is used by both telescopic tubes to create the fixed pivot point. The bottom pivot for both the left telescopic tube and the right telescopic tube is rotatably connected to the platform. The bottom pivot of the left telescopic tube is aligned with both left oblique tracks, and the bottom pivot of the right telescopic tube is aligned with both right oblique tracks, which allows the front and the back of both the telescopic tubes to properly guided by the bottom pivot and the oblique tracks. In addition, the bottom pivot of both the left telescopic tube and the right telescopic tube is positioned adjacent to each other. The configuration of the bottom pivot, the left oblique tracks, and the right oblique tracks allows the angle between the left telescopic tube and right telescopic tube to increase when the viewing object is closer to the present invention. Also in an alternate embodiment of the present invention, the two bottom pivots can be inserted into two female rectangular grooves, which are located adjacent to each other and position on the platform.

The fixed pivoting mount also implements the fixed pivot point for the front of each telescopic tube. The fixed pivoting mount comprises a mount base, a mount beam, a left fixed pivot, and a right fixed pivot. The mount base is used to situate the fixed pivoting mount on the platform, and, thus, the mount base is connected normal to the platform in between the left telescopic tube and the right telescopic tube. The mount beam is used to position the left fixed pivot above the left telescopic tube and is used position the right fixed pivot above the right telescopic tube. Thus, the mount beam is positioned above the left telescopic tube and the right telescopic tube, and the left fixed pivot and the right fixed pivot are positioned opposite to each other along the mount beam. In order to situate the mount beam, the mount beam is centrally connected to the to the mount base opposite to the platform. The configuration of the components of the fixed pivoting mount allows the first cylinder of the left telescopic tube to be pivotally connected to the mount beam by the left fixed pivot and allows the first cylinder of the right telescopic tube to be pivotally connect to the mount beam by the right fixed pivot. For the left telescopic tube, the left fixed pivot and the bottom pivot are concentrically positioned to each other in order to form one fixed pivot point for the front of the left telescopic tube. Similarly for the right telescopic tube, the right fixed pivot and the bottom pivot are concentrically positioned to each other in order to form one fixed pivot point for the front of the right telescopic tube.

The lateral movement mechanism moves the back of both the telescopic tubes in order to increase or decrease the angle between the left telescopic tube and the right telescopic tube. In preferred embodiment of the present invention, the lateral movement mechanism comprises a hand wheel, a wheel pin, a mechanism base, a gear enclosure, a top bevel gear, a left bevel gear, a right bevel gear, a bottom bevel gear, a top gear axle, a bottom gear axle, a left gear axle, a right gear axle, a left extension rod, a right extension rod, a left brace, and a right brace. The mechanism base is used to situate the lateral movement mechanism on the platform, and, thus, the mechanism base is connected normal to the platform in between the left telescopic tube and the right telescopic tube. The gear enclosure is connected to the mechanism base opposite to the platform and is used to prevent damage and misalignment to the bevel gears. The hand wheel is positioned above the gear enclosure and allows the user to provide rotational motion, which can be transformed into linear motion and create lateral movement for the back of both telescopic tubes.

All of the bevel gears are located within the gear enclosure. For the configuration of the bevel gears, the left bevel gear is perpendicularly engaged to the top bevel gear, and the right bevel gear is perpendicularly engaged to the top bevel gear opposite to the left bevel gear. The bottom bevel gear is perpendicularly engaged to both the left bevel gear and the right bevel gear and is positioned opposite to the top bevel gear. For the configuration of the gear axles, the top gear axle traverses through the gear enclosure to concentrically connect the hand wheel to the top bevel gear. The bottom gear axle allows the bottom bevel gear to be rotatably connected to the gear enclosure adjacent to the mechanism base. The left gear axle traverses through the gear enclosure in order to concentrically connect to the left bevel gear. Likewise, the right gear axle traverses through the gear enclosure in order to concentrically connect to the right bevel gear. In addition, the left gear axle and the right gear axle each comprise a threaded hole. The threaded hole of the left gear axle is positioned opposite to the left bevel gear, and the threaded hole of the right gear axle is positioned opposite to the right bevel gear. The left extension rod and the right extension rod each comprise a threaded portion, which respectively engages to threaded hole of either left axle gear or the right axle gear. The lateral movement mechanism uses the following procedure: first, the user rotates the hand wheel, which rotates the top gear; second, rotational motion is transferred to the left/right bevel gear and the left/right gear axle; third, the bottom bevel gear stabilizes the other bevel gears; fourth, the threaded hole and the threaded portion transforms the rotational motion into linear motion, which moves the left/right extension rod and creates the lateral movement for the left/right telescopic rod.

The left brace and the right brace are used to respectively bracket the left telescopic tube and the right telescopic tube so that the lateral movement mechanism can steadily move either the left telescopic tube and the right telescopic tube. The left brace and the right brace each comprise a top end and a lateral end. For the configuration of the braces, the left brace is positioned around the first cylinder of the left telescopic tube. The left extension rod is pivotally connected to the top end of the left brace and to the first cylinder of the left telescopic tube. The threaded portion of the left extension rod is also positioned opposite to the top end of the left brace. The lateral end of the left brace is connected to the first cylinder of the left telescopic tube. Similarly, the right brace is positioned around the first cylinder of the right telescopic tube. The right extension rod is pivotally connected to the top end of the right brace and to the first cylinder of the right telescopic tube. The threaded portion of the right extension rod is also positioned opposite to the top end of the right brace. The lateral end of the right brace is connected to the first cylinder of the right telescopic tube.

In preferred embodiment, the present invention utilizes different dimensions between certain components. The left telescopic tube and the right telescopic tube are positioned 25.5 millimeters from each other. The center of the lens for the left telescopic tube is positioned seven centimeters from the center or the lens of the right telescopic tube. The distance between the mount beam and the braces is five centimeters.

The following includes some miscellaneous information regarding the preferred embodiment of the present invention. The closer the distance from DSLR camera to object being pictured, the greater the length from the lens to the plate. As these two DSLR cameras focus closer in distance, they swerve toward each other, both focusing on the same spot. There is a curve required in the left oblique track and the right oblique track in order to expand of the plate relative to the distance of the object. The lenses are at the beginning of the first cylinders, the plates are at the back of the second cylinders. Within those same second cylinders are the two DSLR cameras that focus on their plate. Both the forward first cylinders with the lenses and the aft second cylinders with the plates have a male extension on their top and bottom to keep everything in place. As the machine extends outward, the plates curve back and those male extensions guided by the female lines of the base. At the center of the plates, there are the small poles that are raised to the right distance from the lens so that the pole in the center is always a clear picture from the lens, and they alone are the only parts clear on the plates, and therefore also on an electronic viewing screen. Those are the spots at which the DSLR cameras are always looking. As the receivers of DSLRs are bonded together with a display on the screen for use of the camera person, one knows when to turn the hand for distance; slowly with the circle, or faster with smaller pin around the edge of that circle. The plates might be better made as a screen, so that that much less is seen clearly on the side. Experimentation will tell. This type of video taken through the present invention need not be thought of as the machine being used throughout a story, a documentary or movie, but some interesting part within a story; two different “points of view”.

Although the invention has been explained in relation to its preferred embodiment, it is to be understood that many other possible modifications and variations can be made without departing from the spirit and scope of the invention as hereinafter claimed.

What is claimed is:

1. A human-perspective stereoscopic camera comprises,
a left telescopic tube;
a right telescopic tube;
a platform;
a channel;
a fixed pivoting mount;
a lateral movement mechanism;
said left telescopic tube and said right telescopic tube each comprise a first cylinder, a second cylinder, and an optics assembly;
said fixed pivoting mount comprises a mount base, a mount beam, a left fixed pivot, and a right fixed pivot;
said first cylinder comprises a bottom pivot;
said second cylinder comprises a top lateral guide and a bottom lateral guide; and
said optics assembly comprises a lens, a digital single-lens reflex (DSLR) camera, a camera mount, a plate, and a pole.

2. The human-perspective stereoscopic camera as claimed in claim 1 comprises,
said second cylinder traversing into said first cylinder;
said second cylinder being sleeved by said first cylinder;
said lens being encircled within said first cylinder opposite to said second cylinder;
said plate being encircled within said second cylinder opposite to said first cylinder;
said DSLR camera being positioned in between said lens and said plate;
said DSLR camera being connected to said second cylinder by said camera mount;
said pole being positioned in between said DSLR camera and said plate;
said pole being centrally positioned and connected normal to said plate; and
said DSLR camera being angled towards said pole by said camera mount.

3. The human-perspective stereoscopic camera as claimed in claim 1 comprises,
said platform being positioned below and parallel to said left telescopic tube and said right telescopic tube;
said second cylinder of said left telescopic tube and said second cylinder of said right telescopic tube being traversing into said channel;
said channel being connected adjacent to said platform;
said fixed pivoting mount being positioned opposite of said channel along said left telescopic tube and said right telescopic tube;
said lateral movement mechanism being positioned in between said fixed pivoting mount and said channel along said left telescopic tube and said right telescopic tube;
said channel comprises a web, a top flange, and a bottom flange; and
said top flange and said bottom flange each comprise a left oblique track and a right oblique track.

4. The human-perspective stereoscopic camera as claimed in claim 3 comprises,
said web being positioned in between said top flange and said bottom flange;
said web being perpendicularly connected to said top flange and said bottom flange;
said top flange being positioned above said left telescopic tube and said right telescopic tube; and
said bottom flange being positioned below said left telescopic tube and said right telescopic tube.

5. The human-perspective stereoscopic camera as claimed in claim 3 comprises,
said left oblique track of said top flange and said left oblique track of said bottom flange being aligned to each other;
said left oblique track of said top flange being engaged by said top lateral guide of said left telescopic tube; and
said left oblique track of said bottom flange being engaged by said bottom lateral guide of said left telescopic tube.

6. The human-perspective stereoscopic camera as claimed in claim 3 comprises,
said right oblique track of said top flange and said right oblique track of said bottom flange being aligned to each other;
said right oblique track of said top flange being engaged by said top lateral guide of said right telescopic tube; and
said right oblique track of said bottom flange being engaged by said bottom lateral guide of said right telescopic tube.

7. The human-perspective stereoscopic camera as claimed in claim 3 comprises,
said bottom pivot of said left telescopic tube being aligned with said left oblique track of said top flange and said left oblique track of said bottom flange;
said bottom pivot of said right telescopic tube being aligned with said right oblique track of said top flange and said right oblique track of said bottom flange;
said bottom pivot of said left telescopic tube and said bottom pivot of said right telescopic tube being rotatably connected to said platform; and
said bottom pivot of said left telescopic tube and said bottom pivot of said right telescopic tube being aligned adjacent to each other.

8. The human-perspective stereoscopic camera as claimed in claim 1 comprises,
said mount base being connected normal to said platform in between said left telescopic tube and said right telescopic tube;
said mount beam being positioned above said left telescopic tube and said right telescopic tube;
said mount beam being centrally connected to said mount base opposite of said platform;
said left fixed pivot and said right fixed pivot being positioned opposite to each other along said mount beam;
said first cylinder of said left telescopic tube being pivotally connected to said mount beam by said left fixed pivot; and
said first cylinder of said right telescopic tube being pivotally connected to said mount beam by said right fixed pivot.

9. The human-perspective stereoscopic camera as claimed in claim 1 comprises,
said lateral movement mechanism comprises a hand wheel, a wheel pin, a mechanism base, a gear enclosure, a top bevel gear, a left bevel gear, a right bevel gear, a bottom bevel gear, a top gear axle, a bottom gear axle, a left gear axle, a right gear axle, a left extension rod, a right extension rod, a left brace, and a right brace;
said left gear axle and a right gear axle each comprise a threaded hole;
said left extension rod and said right extension rod each comprise a threaded portion; and
said left brace and said right brace each comprise a top end and a lateral end.

10. The human-perspective stereoscopic camera as claimed in claim 9 comprises,
said mechanism base being connected normal to said platform in between said left telescopic tube and said right telescopic tube;
said gear enclosure being connected to said mechanism base opposite to said platform;
said hand wheel being positioned adjacent to said gear enclosure opposite to said mechanism base; and
said wheel pin being rotatably connected atop said hand wheel.

11. The human-perspective stereoscopic camera as claimed in claim 9 comprises,
said top bevel gear, said bottom bevel gear, said left bevel gear, and said right bevel gear being located within said gear enclosure;
said left bevel gear being perpendicularly engaged to said top bevel gear;
said right bevel gear being perpendicularly engaged to said top bevel gear opposite of said left bevel gear;
said bottom bevel gear being perpendicularly engaged to both said left bevel gear and said right bevel gear opposite to said top bevel gear;
said bottom bevel gear being rotatably connected to said gear enclosure by said bottom gear axle adjacent to said mechanism base;
said top gear axle traversing through said gear enclosure in order to concentrically connect said top bevel gear to said hand wheel;
said left gear axle traversing through said gear enclosure in order to concentrically connect to said left bevel gear;
said right gear axle traversing through said gear enclosure in order to concentrically connect to said right bevel gear;
said threaded hole of said left gear axle being positioned opposite of said left bevel gear; and
said threaded hole of said right gear axle being positioned opposite of said right bevel gear.

12. The human-perspective stereoscopic camera as claimed in claim 9 comprises,
said threaded hole of said left gear axle being engaged by said threaded portion of said left extension rod;
said left brace being positioned around said first cylinder of said left telescopic tube;
said left extension rod being pivotally connected to said top end of said left brace and to said first cylinder of said left telescopic tube, wherein said threaded portion of said left extension rod is positioned opposite to said top end of said left brace;
said lateral end being connected to said first cylinder of said left telescopic tube;
said threaded hole of said right gear axle being engaged by said threaded portion of said right extension rod;
said right brace being positioned around said first cylinder of said right telescopic tube;
said right extension rod being pivotally connected to said top end of said right brace and to said first cylinder of said right telescopic tube, wherein said threaded portion of said right extension rod is positioned opposite to said top end of said right brace; and
said lateral end being connected to said first cylinder of said right telescopic tube.
